(19) United States
(12) Patent Application Publication
(10) Pub. No.: US 2025/0143297 A1
(43) Pub. Date: May 8, 2025

(54) Arthropod Control Compositions

(71) Applicant: FIRMENICH SA, TE Heerlen (NL)

(72) Inventors: Vincent HARRACA, Satigny (CH); Eduardo HATANO, Satigny (CH)

(73) Assignee: FIRMENICH SA, Satigny (CH)

(21) Appl. No.: 18/730,196

(22) PCT Filed: Jan. 17, 2023
(86) PCT No.: PCT/EP2023/050965

§ 371 Date: Jul. 18, 2024

(30) Foreign Application Priority Data
Jan. 18, 2022 (EP) 22152053.9

(51) Int. Cl. A01N 35/02; A01P 17/00

(52) U.S. Cl. CPC A01N 35/02; A01P 17/00

(57) ABSTRACT

The present invention relates to arthropod control compositions, methods and uses to control arthropods as well as arthropod control articles comprising the same.

### TECHNICAL FIELD

The present invention relates to arthropod control compositions, methods and uses to control arthropods as well as arthropod controlling articles comprising the same.

### BACKGROUND

Many mammals, including humans, are suffering from the action of arthropods. Some arthropods, such as for example mosquitoes and ticks, are not desirable for vertebrates such as mammals and in particular human subjects as they bite and, consequently, cause itching, transmission of diseases and/or germs or may be the cause for other diseases and/or conditions. Similarly, other pests indirectly affect human activity or society by eating, parasitizing, or destroying plant materials that are used as food, feed or raw materials. Still further pests are involved in the destruction or weakening of furniture or structures used or built by humans. These damages may directly be attributed to the arthropods or by their capability of spreading germs causing such issues.

Arthropod control compositions include active substances and when applied to skin, clothing, or other surfaces, they may discourage arthropods from landing or climbing on that surface. Arthropod control agents help preventing and controlling the outbreak of arthropod-borne diseases, such as malaria, etc.

Some of the known arthropod controlling agents and composition, however, have certain drawbacks as they can have negative effects, i.e. negative olfactive properties, such as no or bad smell, or in turn only weak arthropod controlling, in particular arthropod repelling properties.

There is a need to provide arthropod control compositions that have both good olfactive properties, i.e. a good hedonic effect, and good arthropod controlling, in particular arthropod repelling properties.

The prior art does not disclose or suggest the arthropod control compositions according to the present invention.

### DETAILED DESCRIPTION

The present invention provides arthropod, preferably insect, control composition comprising a compound of formula (I)

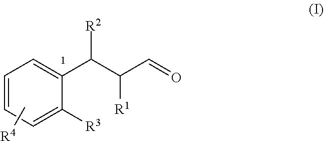

in the form of any one of its isomers or a mixture thereof;
wherein R¹, R² and R³, independently from each other, represent, a hydrogen atom or a C₁₋₃ alkyl group; R⁴ represents a C₁₋₃ alkoxy group or a C₁₋₆ alkyl group, optionally substituted by a hydroxy or a C₁₋₃ alkoxy group; said R⁴ being, relative to position 1, a meta, a para substituent of the aromatic ring; provided that 3-(4-isopropylphenyl)-2-methylpropanal is excluded.

For the sake of clarity, by the expression “any one of its stereoisomers or a mixture thereof”, or the similar, it is meant the normal meaning understood by a person skilled in the art, i.e. that the compound of formula (I) can be a pure enantiomer or diastereomer. In other words, the compound of formula (I) may possess one or several stereocenters and each of said stereocenter can have two different stereochemistries (e.g. R or S). The compound of formula (I) may even be in the form of a pure enantiomer or in the form of a mixture of enantiomers or diastereoisomers. The compound of formula (I) can be in a racemic form or scalemic form. Therefore, the compound of formula (I) can be one stereoisomer or in the form of a composition of matter comprising, or consisting of, various stereoisomers.

The term “alkyl” is understood as comprising branched and linear alkyl groups.

The term “optionally” is understood that a certain group to be optionally substituted can or cannot be substituted with a certain functional group.

According to any one of the above embodiments of the invention, R¹ may be a hydrogen atom, or a methyl or an ethyl group. Particularly, R¹ may be a hydrogen atom, or a methyl group.

According to any one of the above embodiments of the invention, R² may be a hydrogen atom, or a methyl or an ethyl group. Particularly, R² may be a hydrogen atom, or a methyl group. Even more particularly, R² may be a hydrogen atom.

According to any one of the above embodiments of the invention, R³ may be a hydrogen atom, or a methyl or an ethyl group. Particularly, R³ may be a hydrogen atom, or a methyl group.

According to any one of the above embodiments of the invention, one group among R¹, R² and R³ may be a hydrogen atom or a C₁₋₃ alkyl group and the two other groups may be a hydrogen atom. Particularly; one group among R¹, R² and R³ may be a hydrogen atom or a methyl group and the two other groups may be a hydrogen atom. Even more particularly, R¹ may be a hydrogen atom or a methyl group and R² and R³ may be a hydrogen atom or R³ may be a hydrogen atom or a methyl group and R² and R³ may be a hydrogen atom.

According to any one of the above embodiments of the invention, R⁴ may be a methoxy group or a C₁₋₄ alkyl group, optionally substituted by a hydroxy or a C₁₋₃ alkoxy group. Particularly, R⁴ may be a methoxy group or a C₃₄ alkyl group, optionally substituted by a hydroxy or a methoxy group. Particularly, R⁴ may be a methoxy group or a C₃₋₄ branched alkyl group, optionally substituted a methoxy group.

According to any one of the above embodiments of the invention, R⁴ may be a para substituent of the aromatic ring. In other words, the compound of formula (I) may a compound of formula (II)

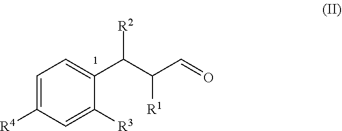

in the form of any one of its isomers or a mixture thereof; wherein R¹, R², R³ and R⁴ have the same meaning as defined above.

According to any one of the above embodiments of the invention, the compound of formula (II) may a compound of formula (III)

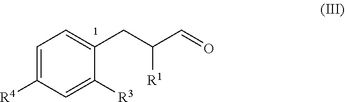

in the form of any one of its isomers or a mixture thereof; wherein R¹, R³ and R⁴ have the same meaning as defined above.

According to any one of the above embodiments of the invention, the compound of formula (I) may be selected from the group consisting of 3-[4-(2-methoxy-2-propanyl)-2-methylphenyl]propanal [2637928-74-4], 3-[4-(2-hydroxy-2-methylpropyl)phenyl]propanal [1896908-71-6], 3-(4-tert-butyl-2-methylphenyl) propanal [160782-57-0], 3-(4-tert-butylphenyl) propanal [18127-01-0], 3-(3-propan-2-ylphenyl) butanal [125109-85-5] and 3-(4-methoxyphenyl)-2-methylpropanal [5462-06-6].

Particularly, the compound of formula (I) may be selected from the group consisting of 3-[4-(2-hydroxy-2-methylpropyl)phenyl]propanal [1896908-71-6], 3-(4-tert-butyl-2-methylphenyl) propanal [160782-57-0], 3-(4-tert-butylphenyl) propanal [18127-01-0], 3-(3-propan-2-ylphenyl) butanal [125109-85-5] and 3-(4-methoxyphenyl)-2-methylpropanal [5462-06-6].

It can be appreciated that each of the embodiments of the invention as provided herein may not comprise 100% of the composition of the invention. In such circumstances additional components can be used, for example to further improve the hedonic profile or adapt the hedonic profile for specific application by the consumer of the composition, solvents to aid the delivery of the composition of the invention, stabilizers and preservatives to improve the integrity and conservation of the composition as may be needed for anticipated use by the consumer. Further components include additional arthropod control co-ingredients as provided below

In a preferred embodiment of the invention the arthropod control composition has a good hedonic profile.

The present inventors have good appreciated that it may be desirable for arthropod control compositions to have an acceptable hedonic profile. This is because the compositions may be used in close proximity to a consumer and, as can be understood, any unpleasant hedonic profile may inhibit the use of the composition.

The term “arthropod” has the normal meaning for a skilled person in the technical field. Arthropods include invertebrate animals, such as insects, arachnids, and crustaceans, that have a segmented body and jointed appendages. Arthropods usually have a chitinous exoskeleton molted at intervals, and a dorsal anterior brain connected to a ventral chain of ganglia.

Arthropods in the present invention's understanding relate to undesired arthropods, meaning that their presence in the air, on the surface of an article, the surface of a plant or the surface of a vertebrate, such as a human subject or other mammal, preferably human subject, is not desired. Preferably undesired arthropods are pest arthropods that impact plants and animals, e.g. thrips, aphids, beetles, moth, mealybug, scale etc., more preferably pest arthropods that impact animals, e.g. ants, termites, cockroaches, flies, etc., even more preferably blood feeding arthropods that impact vertebrates, e.g. biting fly, bed bug, kissing bug, flea, lice, mosquitos and ticks, even more preferably mosquitos and ticks.

The reason why the presence of an arthropod is not desired might be that the arthropod's presence in the air is unpleasant to a subject, the contact of an arthropod on an article transfers diseases and/or germs or the arthropod bites an organism and causes itching, the transmission of diseases and/or germs or the arthropod feeding may be the cause for other diseases and/or conditions.

In a particular embodiment, the arthropod is an insect or an arachnid, preferably an insect.

The term “insect” has the normal understanding by a skilled person the technical field. An insect is described by a well-defined head, thorax, and abdomen, only three pairs of legs, and typically one or two pairs of wings

In a particular embodiment, the insect is a mosquito, biting fly, bedbug, kissing bug, flea, lice, ant, termite, cockroach, fly, aphid, beetle, thrips, moth, mealybug or scale bug, more preferably a mosquito.

The term “arachnid” has the normal understanding by a skilled person the technical field. An arachnid is described having a segmented body divided into two regions of which the anterior bears four pairs of legs but no antennae

In a particular embodiment, the arachnid is a tick, mite, chigger or spider, more preferably a tick.

The expression “control”, “arthropod control”, “insect control” or “arachnid control” or the like has the normal meaning for a skilled person in the technical field.

“Controlling” in the context of the present invention defines the ability of an arthropod controlling composition according to the present invention to attract, deter, kill or repel an arthropod, preferably deter or repel an arthropod and even more preferably repel an arthropod

“Attracting” according to the present invention defines the ability of an arthropod attractant composition according to the invention to increase or encourage contact or the presence of an arthropod at the arthropod attractant source, such as in the air, on the surface of an article or on the surface of a vertebrate, such as a human subject or other mammal, preferably an article such as a trapping device, the arthropod attractant compound or composition has been applied to.

“Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of a vertebrate, such as a human subject or other mammal, preferably human subject, to which the arthropod repellent compound or composition has been applied to.

“Deterring” according to the present invention defines the ability of an arthropod deterrent composition according to the invention to minimize, reduce, discourage or prevent contact or the presence of an arthropod at the arthropod deterrent source, such as in the air, on the surface of an article or on the surface of a vertebrate, such as a human subject or other mammal, preferably human subject, to which the arthropod deterrent compound or composition has been applied to. Typically, the deterrent effect is shown when used as feeding deterrent hindering a pest from subsequent food intake or oviposition or physical contact after an initial tasting of the arthropod deterrent compound or composition.

“Spatial Repellency” according to the present invention defines the ability of an arthropod repellent composition according to the present invention to minimize, reduce, discourage or prevent approach or the presence of an arthropod at the arthropod repellent source, such as in the air, on the surface of an article or on the surface of an vertebrate, such as a human subject or other mammal, preferably human subject, to which the arthropod repellent compound or composition has been applied to. Typically, the spatial repellency effect is shown when spatial repellent compound or composition released, sprayed, spread or diffused in the air or liquid hinder a pest from entering the zone in which the spatial repellent compound or composition is present. Repellence occurs therefore from a distance, the pest not necessarily entering in direct contact with the treated article or organism to protect.

“Killing” according to the present invention defines the ability of arthropod killing composition according to the present invention to kill an arthropod at the arthropod killing source, such as in the air, on the surface of an article or on the surface of a vertebrate, such as a human subject or other mammal, preferably human subject, to which the arthropod killing compound or composition has been applied to. When an arthropod killing composition is applied to a plant, an animal or human subject, it is applied in an amount which is killing to the arthropod but not to the subject.

In a particular embodiment, the arthropod control composition is an arthropod repelling composition, preferably an insect repelling composition, more preferably a mosquito repelling composition.

In a particular embodiment, the arthropod controlling source is the surface and/or the air in the vicinity of an article, preferably a candle, coil, electric diffuser, wristband, patch, collar, ear tag, clothes, fabrics, papers, biochar, cardboard, cellulosic pads, bed nets, screen, curtains, furniture, walls, ground or paint, or the surface of a subject, preferably the surface of a vertebrate, such as a human subject or other mammal, preferably human subject, i.e. the skin of a human subject treated with a product such as spray, aerosol, cream, roll on, wristband, lotion, soap, shampoo, sunscreen or patch or a cloth treated with a product such as laundry powder, liquid detergent, spray, lotion, powder.

The arthropod controlling effect according to the present invention is determined on mosquitoes using an adapted Warm Body assay as defined in Kröber T, Kessler S, Frei J, Bourquin M, Guerin PM. An in vitro assay for testing mosquito controlling compounds employing a warm body and carbon dioxide as a behavioral activator. J Am Mosq Control Assoc. 2010; 26:381-386. Further information is provided in the accompanying examples

The controlling effect, repellence & spatial repellence, according to the present invention is determined by testing the Warm Body assay against the yellow fever mosquito, Aedes aegypti Rockefeller strain. A. aegypti is a model organism for controlling tests and one of the recommended model organisms by the World Health Organization (WHO) as it is a very aggressive, anthropophilic mosquito species that shows generally low sensitivity to arthropod controlling compounds. Observations of controlling efficacy were made on host-seeking females of uniform age, 5 to 10 days old selected as mentioned in the publication mentioned hereinabove. Tested hungry females had access to 10% sugar solution but were not blood-fed. Further information is provided in the accompanying examples.

The published protocol has been adapted in not manually counting the landing mosquitoes but automatically using an automatic counting software, the switch from Anopheles gambiae to A. aegypti led to a decrease of mosquitoes' number placed in the tested cage due to the size difference (i.e. 30 mosquitoes instead of 50) and to an increase of lighting as A. aegypti is a diurnal mosquitoes (i.e. 150 lux instead of 4 lux). Further information is provided in the accompanying examples.

The controlling effect, repellence & spatial repellence, according to the present invention is also determined according to an arm in the box method adapted from the WHO Guidelines for efficacy repellents testing of mosquito for human skin (WHO/CDS/NTD/WHOPES/2009.4). The readiness of 100 hungry female mosquitoes A. aegypti to a test substance is assessed by comparing the results of an untreated arm to a treated in when inserted into the cage (40×40×40 cm) for 30 seconds (negative control) three times. Further information is provided in the accompanying examples.

The activity for substances to repel arachnids such as ticks may be assessed using the protocol of the in-vitro Warm Plate Assay as defined in Kröber T, Bourquin M, Guerin PM. 2013. A standardized in vivo and in vitro test method for evaluating tick repellents. Pestic. Biochem. Phys. 107 (2): 160-168.

In a particular embodiment, the amount and selection of the substance is in a way that it contributes, enhances or improves both, the arthropod control activity and the hedonic character of the composition.

In one embodiment, the arthropod control composition may further comprise an arthropod control co-ingredient. By “arthropod control co-ingredient” is understood an ingredient capable of imparting additional arthropod controlling benefits to the arthropod controlling effect of the composition herein described.

In one embodiment, the substance herein described is capable to modify, enhance or improve the arthropod controlling effect of the arthropod control co-ingredient, e.g. by reducing the amount of the arthropod control co-ingredient within a composition. This can be particularly beneficial in case the arthropod control co-ingredient is harmful to human subjects at a certain dose or in case the arthropod control co-ingredient has negative olfactive properties at a certain dose.

According to a particular embodiment, the combination of the substance herein described and an arthropod control co-ingredient results in a synergistic arthropod controlling effect.

According to a particular embodiment, the combination of substance herein described and an arthropod control co-ingredient results in a modified, pleasant, enhanced or improved olfactory impression of the overall composition in comparison to its single ingredients.

According to one embodiment arthropod control co-ingredient is selected from the group consisting of: N,N-diethyl-3-methylbenzamide (DEET), ethyl butylacetylaminopropionate (IR3535); para-menthan-3,8-diol (PMD); 1-(1-methylpropoxycarbonyl)-2-(2-hydroxaethyl) piperidin (picaridin); Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil Eucalyptus citriodora oil hydrated cyclized, eugenol, Garlic oil, geraniol, Geranium oil, Lavender, Lavandula hybrida oil, Lavandin oil, Lemon oil, Lemongrass oil, Margosa extract, Metofluthrin, mixture of cis- and trans-p-menthane-3,8 diol, N,N-diethyl-meta-toluamide, nonanoic acid, Rosemary oil, Thyme oil, Wintergreen oil, 2,3,4,5-bis(butyl-2-ene) tetrahydrofurfural (MGK Repellent 11), cineole, cinnamaldehyde, citronellal, citronellol, coumarin, dibutyl phthalate, diethyl phthalate, dimethyl anthranilate, dimethyl phthalate, ethyl vanillin, Eucalyptus oil, delta-octalactone, delta-nonalactone, delta-decalactone, delta-undecalactone, delta-dodecalactone, gamma-octalactone, gamma-nonalactone, gamma-decalactone, gamma-undecalactone, gamma-dodecalactone, hydroxy citronellal, Lime oil, limonene, linalool, methyl anthranilate, Mint oil, myrcene, Neem oil, sabinene, β-caryophyllene, (1H-indol-2-yl) acetic acid, anethole, Anise oil, Basil oil, Bay oil, camphor, ethyl salicylate, Evergreen oils (pine oil), (1,3,4,5,6,7-hexahydro-1,3-dioxo-2H-isoindol-2-yl) methyl 2,2-dimethyl-3-(2-methylprop-1-enyl)cyclopropanecarboxylate (d-Tetramethrin), 3-Allyl-2-methyl-4-oxocyclopent-2-enyl-2,2-dimethyl-3-(2-methylprop-1-enyl)-cyclopropanecarboxy late (d-Allethrin), α-cyano-3phenoxybenzyl, 3-(2,2-dichlorovinyl)-2,2-dimethylcyclopropanecarboxylate (Cypermethrin), 2-methyl-4-oxo-3-(prop-2-ynyl)cyclopent-2-en-1-yl 2,2-dimethyl-3-(2-methylprop-1-enyl)cyclopropanecarboxylate (Prallethrin), Acetamiprid, Azadirachtin, Bendiocarb, Bifenthrin, boric acid, Chlorpyrifos, Deltamethrin, Diazinon, Dichlorvos, eugenol, Fipronil, Imidacloprid, linalool, Malathion, Maltodextrin, Metofluthrin, Nicotine, Permethrin, Pyrethrins, Pyrethroids, Rotenone, silicium dioxide (Kieselguhr), S-Methoprene, Spinosad (Spinosyn A), Spinosyn D, Tetramethrin, Transfluthrin, 1-(2,6,6-trimethylcyclohex-2-en-1-yl) but-2-en-1-one, 3-butylidene-2-benzofuran-1-one, 4-ethenyl-2-methoxyphenol, Cognac oil green, Labdanum extract (Cistus spp.), 5-pentyloxolan-2-one, chromen-2-one, 3,7-dimethylocta-2,6-dienal, 4-hydroxy-3-methoxybenzaldehyde, 2-methyl-5-prop-1-en-2-ylcyclohex-2-en-1-one, Mentha spicata oil, 6-hexyloxan-2-one, 5-methyl-2-propan-2-ylcyclohexyl]acetate, Nigella damascena oil, 2-phenylethanol, 6-pentyloxan-2-one, (4-methoxyphenyl) methyl acetate, Syzygium aromaticum oil, 3,4,4a,5,6,7,8,8a-octahydrochromen-2-one, 3,7,7-trimethylbicyclo[4.1.0]hept-3-ene, 2-phenylethyl 2-methylpropanoate, methyl 2-(3-oxo-2-pent-2-enylcyclopentyl)acetate, 4-(2-methoxypropan-2-yl)-1-methylcyclohexene, Mentha piperita oil, 2-methoxy-4-[prop-1-enyl]phenol, 2-methyl-3-(4-propan-2-ylphenyl) propanal, (4-methoxyphenyl) methanol, and mixtures thereof.

In a particular embodiment, the arthropod control co-ingredient is comprised in an amount of from 0.02 to 80 wt. %, more preferably in an amount of from 0.05 to 70 wt. %, even more preferably in an amount of from 0.1 to 60 wt. %, based on the total weight of the composition. Thereby, it is understood that the composition comprises the arthropod control co-ingredient in a minimum amount of at least 0.02 wt. %, at least 0.05 wt. % or at least 0.1 wt. % and a maximum amount of not more than 80 wt. %, not more than 70 wt. % or not more than 60 wt. %, based on the total weight of the composition.

In a particular embodiment, within the limitations of the amount of the substance in the composition as stated above, the substance in the composition of the invention and the arthropod control co-ingredient are comprised in the composition in a weight range of 90:10 to 10:90, preferably in a weight range of 80:20 to 20:80, more preferably in a weight range of 65:35 to 35:65 and most preferably in a weight range of 60:40 to 40:60. It is herein also understood that substance and the arthropod control co-ingredient can be comprised in the composition in any weight range combination as mentioned herein-before, such as 90:10 to 20:80, preferably 35:65 and more preferably 40:60, 80:20 to 10:90, preferably 35:65 and more preferably 40:60, 65:35 to 10:90, preferably 20:80 and more preferably 40:60 or 40:60 to 10:90, preferably 20:80 and more preferably 35:65.

In one embodiment, the arthropod control composition may further comprise perfume ingredients. Perfume ingredients are understood as contributing, modifying, enhancing or improving the olfactory character of the composition but do not contribute to, enhance or improve the arthropod controlling effect of the composition. Perfume ingredients providing such hedonic effects and suitable for use in the composition of the invention are known in the art and can be readily identified by the skilled person.

The arthropod control composition can further comprise a carrier. By “carrier” is understood a material with which the active compound is mixed or formulated to facilitate its application a locus or other object to be treated, or its storage, transport and/or handling. Said carrier may be of inorganic or organic or of synthetic natural origin. Said carrier may be a liquid or a solid.

As liquid carrier one may cite, as non-limiting examples, an emulsifying system, i.e. a solvent and a surfactant system, or a solvent commonly used in perfumery. A detailed description of the nature and type of solvents commonly cannot be exhaustive. However, one can cite as non-limiting examples, solvents such as butylene or propylene glycol, glycerol, dipropylene glycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethanol, tri-ethyl citrate, 2-methylprop-1-ene and 2-(2-ethoxyethoxy) ethanol or mixtures thereof, particular suitable are dipropylene glycol, 2-methylprop-1-ene and 2-(2-ethoxyethoxy) ethanol and mixtures thereof.

For the compositions which comprise both a carrier, other suitable carriers than those previously specified, can be also ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company) like Dowanol™ DPMA (Glycol Ether Acetate), or Augeo® Clean Multi (isopropylidene glycerol; origin: Solvay), or hydrogenated castors oils such as those known under the trademark Cremophor® RH 40 (origin: BASF).

Solid carrier is meant to designate a material to which the arthropod control composition or some element of the arthropod control composition can be chemically or physically bound. In general, such solid carriers are employed either to stabilize the composition, or to control the rate of evaporation of the compositions or of some ingredients. The use of solid carrier is of current use in the art and a person skilled in the art knows how to reach the desired effect. However, by way of non-limiting example of solid carriers, one may cite absorbing gums or polymers or inorganic material, such as porous polymers, cyclodextrins, wood based materials, organic or inorganic gels, clays, gypsum talc or zeolites.

As other non-limiting examples of solid carriers, one may cite encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or other such materials. The encapsulation is a well-known process to a person skilled in the art, and may be performed, for instance, by using techniques such as spray-drying, agglomeration or yet extrusion; or consists of a coating encapsulation, including coacervation and complex coacervation technique.

As non-limiting examples of solid carriers, one may cite in particular the core-shell capsules with resins of aminoplast, polyamide, polyester, polyurea or polyurethane type or a mixture thereof (all of said resins are well known to a person skilled in the art) using techniques like phase separation process induced by polymerization, interfacial polymerization, coacervation or altogether (all of said techniques have been described in the prior art), optionally in the presence of a polymeric stabilizer or of a cationic copolymer.

Resins may be produced by the polycondensation of an aldehyde (e.g. formaldehyde, 2,2-dimethoxyethanal, glyoxal, glyoxylic acid or glycolaldehyde and mixtures thereof) with an amine such as urea, benzoguanamine, glycoluryl, melamine, methylol melamine, methylated methylol melamine, guanazole and the like, as well as mixtures thereof. Alternatively, one may use preformed resins alkylolated polyamines such as those commercially available under the trademark Urac® (origin: Cytec Technology Corp.), Cymel® (origin: Cytec Technology Corp.), Urecoll® or Luracoll® (origin: BASF).

Others resins one are the ones produced by the polycondensation of an a polyol, like glycerol, and a polyisocyanate, like a trimer of hexamethylene diisocyanate, a trimer of isophorone diisocyanate or xylylene diisocyanate or a Biuret of hexamethylene diisocyanate or a trimer of xylylene diisocyanate with trimethylolpropane (known with the tradename of Takenate®, origin: Mitsui Chemicals), among which a trimer of xylylene diisocyanate with trimethylolpropane and a Biuret of hexamethylene diisocyanate.

Many articles have been published relating to the encapsulation by polycondensation of amino resins, namely melamine-based resins with aldehydes. Such articles already describe the various parameters affecting the preparation of such core-shell microcapsules. These documents are known to the skilled person and the contents therein be used in the field of the present invention.

The present invention also relates to a method for arthropod, preferably insect, control which comprises bringing an arthropod, preferably insect, into direct contact or in contact with vapors of a composition as described hereinabove.

For the sake of clarity, the arthropod controlling composition according to the present invention can be applied to the air, to the surface of an article, the air in the vicinity of the surface of an article or the surface of a subject by usual methods known in the art such as spraying, applying, wearing or diffusing.

In a particular embodiment, the arthropod controlling composition according to the present invention is applied to the surface of an article, the air in the vicinity of the surface of an article or to the surface of an animal or subject.

In a particular embodiment, the article can be an arthropod control article as described hereinbelow and in particular, can be a candle, coil, electric diffuser, wristband, patch, collar, ear tag, clothes, fabrics, papers, biochar, cardboard, cellulosic pads, bed nets, screen, curtains, furniture, paint, walls, ground, spray, aerosol, cream, roll on, wristband, lotion, soap, shampoo, sunscreen, laundry powder, liquid detergent, spray, lotion, powder.

In a particular embodiment, the surface of a subject is the surface of a human or animal subject, preferably the surface is a human subject, i.e. the skin of a human subject.

The present invention also relates to a use of a composition as defined hereinabove to control arthropods, preferably insects.

The present invention also relates to an arthropod control article comprising the arthropod control composition as described hereinabove.

By “arthropod control article” is understood to designate a consumer product which delivers at least an arthropod controlling effect to the surface or space to which it is applied (e.g. skin, hair, textile, or home surface). In other words, an arthropod controlling article according to the invention is a consumer product which comprises a functional formulation, as well as optionally additional benefit agents, corresponding to the desired consumer product, and an arthropod controlling amount of at least one of the substances. For the sake of clarity, said consumer product is a non-edible product.

The nature and type of the constituents of the consumer product do not warrant a more detailed description here, which in any case would not be exhaustive, the skilled person being able to select them on the basis of his general knowledge and according to the nature and the desired effect of said product.

Non-limiting examples of suitable consumer products include a perfume, such as a fine perfume, a splash or eau de parfum, a cologne or a shave or after-shave lotion or a cream or gel; a fabric care product, such as a liquid or solid detergent, a laundry powder, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product), a dental care product, a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc.); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner; a candle; a spray, a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint, more preferably a candle, a spray, a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint.

In a preferred embodiment of the invention, the consumer product is an electric diffuser. In this embodiment of the invention, the substance in the arthropod, preferably insect, control composition is present at certain quantities.

Some of the above-mentioned consumer products may represent an aggressive medium for the members of the substances, so that it may be necessary to protect the latter from premature decomposition, for example by encapsulation or by chemically binding it to another chemical which is suitable to release the invention's ingredient upon a suitable external stimulus, such as an enzyme, light, heat or a change of pH.

The invention will be described in further detail by way of the following non-limiting examples.

### EXAMPLES

### 1. Experimental Protocols and Methods Used Herein

### Warm Body Assay is the Small-Scale Test Used to Screen the Repellent Efficacy on Mosquitoes at 3-15 Concentrations at T0.

Aedes aegypti is a model organism for controlling tests and one of the recommended model organisms by the World Health Organization (WHO) as it is a very aggressive anthropophilic mosquito species that shows generally low sensitivity to arthropod controlling compounds. Anopheles gambiae is also a model organism as it is anthropophilic and transmits malaria.

The controlling effect according to the present invention was assessed using an adapted Warm Body assay as defined in Kröber T, Kessler S, Frei J, Bourquin M, Guerin PM. 2010. J Am Mosq Control Assoc. 26:381-386. In this in-vitro assay the number of mosquito landing on a warm body, simulating an attractive host treated with the tested stimuli, was measured in order to assess the repellence effect.

The published protocol has been adapted as the switch from Anopheles gambiae to Aedes aegypti led to a decrease of mosquitoes placed in the tested cage due to the size difference (i.e. 30 mosquitoes instead of 50) and to an increase of lighting since A. aegypti is a diurnal mosquitoes (i.e. 150 lux instead of 4 lux).

### Double Chamber Assay is the Small-Scale Test Used to Screen the Spatial Repellent Efficacy on Mosquitoes at One Concentration Between 0 and 40 Minutes.

The goal of this assay was to reproduce at a smaller scale the validation test for spatial repellent as described in WHO (2013; ISBN 978 92 4 150502 4).

The assay consists of a transparent cage (1200×755×700 mm; ˜0.63 m³) covered by white paper. This cage is divided in two chambers of equal dimensions by a plasticized paper wall with square opening (200×200 mm) situated in the middle of the wall. At the beginning of the experiment, about 40 two-weeks old female Aedes aegypti mosquitoes are placed in the right chambers. Once the mosquitoes are settled inside this chamber (>5 min), the door between the chambers is opened. Then the stimulus is introduced into the mosquito chamber through a L-shape Teflon tube (40 mm) placed in the middle of the right Plexiglas wall. The stimulus is dispensed thanks to a Forced Evaporation System (Chappuis et al, 2015, DOI: 10.1021/acs.est.5b00692) at a rate of 0.1 mL/min in a nitrogen flow of 1 L/min, blended in a humid air flow of 9 L/min before being carried to the L-shape Teflon tube. An air sucking system (˜150 L/min) is placed above the wall opening, between the two chambers (100 mm Ø), preventing the untreated chamber from being contaminated by the stimulus and limiting the stimulus accumulation in the treated chamber. The untreated chamber thus provides a “refuge” for the mosquitoes escaping the stimulus of treated chamber. Ten, 20, 30 and 40 minutes after the start of the stimulus injection, the number of mosquitoes that have moved to the untreated chamber is manually counted.

### Arm-In-Cage Test is the Large-Scale Test Used to Assess on Human Volunteer the Repellent Efficacy on Mosquitoes.

The Arm in the box method was adapted from the WHO Guidelines for efficacy testing of mosquito repellents for human skin (WHO/CDS/NTD/WHOPES/2009.4). The readiness of 100 hungry female mosquitoes A. aegypti to probe is assessed by inserting an untreated arm into the cage (40×40×40 cm) for 30 seconds (negative control) three times (once at the beginning, once at the fourth hour and once at the eighth hour), to determine probing activity. Then, the product is applied onto the skin of the forearm of a human volunteer (1 mL per 600 cm²) and after 5 minutes, this arm is inserted into the cage and exposed for 3 minutes. The assay take place in temperature (27±2° C.) and humidity (80±10% RH) regulated room on three different volunteers.

### Warm Plate Assay is the Small-Scale Test Used to Screen the Repellent Efficacy on Ticks at Different Concentrations at T0.

Repellent efficacy of the different compounds was assessed against the castor bean tick, Ixodes ricinus L that can transmit both bacterial and viral pathogens. I. ricinus is one of the recommended model organisms mentioned by the Guidance on the European Biological Products Regulation [Vol II, Efficacy-Assessment & Evaluation (Parts B+C), v. 3.0, April 2018]. Observations of repellent efficacy were made on last stage nymphs.

The repellent efficacy was assessed using the protocol of the in-vitro Warm Plate Assay as defined in Kröber T, Bourquin M, Guerin PM. 2013. Pestic. Biochem. Phys. 107 (2): 160-168.

### 2. Results of Deterrence and Spatial Repellence Effect on Arthropods

### Warm Body Assay

On the sandblasted glass Petri dish covering the warm body (28.3 cm²), 100 μL of the compounds diluted at different concentrations in ethanol was applied. The number of mosquito landing on the warm body was counted for each stimulus and pure ethanol (solvent) as control.

All stimuli tested elicited a clear increase of repellence linked to the increase of the applied dose (Tables 1, 2 & 3). This really demonstrates a biological repellent effect of the different products on mosquito behavior.

TABLE 1
Percentage of repellence of mosquitoes Aedes aegypti landing on the warm body baited with different stimuli at different concentrations.

| | 0.0032 | 0.0071 | 0.016 | 0.0357 | 0.053 | 0.08 | 0.119 | 0.178 | 0.267 | 0.4 | 0.598 | 0.89 | 2 | 4.47 | 10 |
|---|---|---|---|---|---|---|---|---|---|---|---|---|---|---|---|
| | mg/mL | mg/mL | mg/mL | mg/mL | mg/mL | mg/mL | mg/mL | mg/mL | mg/mL | mg/mL | mg/mL | mg/mL | mg/mL | mg/mL | mg/mL |
| 251 | 0% | 0% | 0% | 61% | 54% | 40% | 52% | 71% | 97% | 79% | 93% | 99% | 96% | 97% | 89% |
| 1389 | 11% | n.d. | 0% | 8% | 74% | 53% | n.d. | 30% | n.d. | 81% | n.d. | 88% | 87% | 84% | 90% |
| 681 | 0% | n.d. | 0% | n.d. | n.d. | 31% | n.d. | n.d. | n.d. | 49% | n.d. | n.d. | 89% | n.d. | 92% |
| 875 | 39% | n.d. | 60% | n.d. | n.d. | 24% | n.d. | n.d. | n.d. | 81% | n.d. | n.d. | 81% | n.d. | 96% |
| 294 | n.d. | n.d. | 57% | n.d. | n.d. | n.d. | n.d. | n.d. | n.d. | 54% | n.d. | n.d. | n.d. | n.d. | 96% |
| 859 | n.d. | n.d. | 21% | n.d. | n.d. | n.d. | n.d. | n.d. | n.d. | 65% | n.d. | n.d. | n.d. | n.d. | 98% |
| 867 | n.d. | n.d. | 13% | n.d. | n.d. | n.d. | n.d. | n.d. | n.d. | 27% | n.d. | n.d. | n.d. | n.d. | 81% |

The ten stimuli tested were 3-(4-methoxyphenyl)-2-methylpropanal (251), 3-(3-propan-2-ylphenyl)butanal (1389), 3-[4-(2-methoxy-2-propanyl)phenyl]propanal (681), 3-[4-(2-methoxy-2-propanyl)-2-methylphenyl]propanal (875), 3-(4-tert-butylphenyl)propanal (294), 3-[2-methyl-4-(2-methyl-2-propanyl)phenyl] propanal (859), 3-[4-(2-hydroxy-2-methylpropyl)phenyl]propanal (867). Three to fifteen concentrations were assessed on each stimulus, missing data points mentioned as n.d.. The mean number of mosquito landings with the solvent only (0 mg/mL) is equal to 63 ± 12.6 landings in two minutes.

As displayed in Table 1, despite some variability in measurements, all ten compounds displayed a relevant reduction of the number of mosquito landings due to concentration. Since the dose of 0.0016%, 3-[4-(2-methoxy-2-propanyl)-2-methylphenyl]propanal and 3-(4-tert-butylphenyl) propanal managed to reduce the number of mosquito landing by half (Table 1). At the intermediate dose of 0.04%, 3-(4-methoxyphenyl)-2-methylpropanal, 3-(3-propan-2-ylphenyl) butanal and 3-[4-(2-methoxy-2-propanyl)-2-methylphenyl]propanal all elicited a repellent effect >75% (Table 1). For all the ten stimuli, at all tested concentrations above 0.0598%, the percentage of repellence was >80% (Table 1). Therefore, at the highest dose tested, i.e. 1%, there was never more than 5 mosquitoes landing per minute on the baited attractive stimulus, whereas the number of landing was above 31 landings per minute when untreated (Table 1).

TABLE 2
Percentage of repellence of mosquitoes Anopheles gambiae landing
on the warm body baited with different stimuli at different concentrations.
The five stimuli were tested at two to five concentrations, n.d. meaning
no data. The mean number of mosquito landings with the solvent only
(0 mg/mL) is equal to 46 ± 5.7 landings in two minutes.

| | 0.178 | 0.267 | 0.4 | 4.47 | 10 |
|---|---|---|---|---|---|
| | mg/mL | mg/mL | mg/mL | mg/mL | mg/mL |
| 3-(4-tert-butylphenyl)propanal | 42% | 14% | 55% | 96% | 96% |
| 3-(3-propan-2-ylphenyl)butanal | n.d. | n.d. | n.d. | 58% | 96% |
| 3-(4-methoxyphenyl)-2-methylpropanal | n.d. | n.d. | n.d. | 100% | 96% |
| 3-[4-(2-methoxy-2-propanyl)-2- | 69% | 66% | 93% | 97% | 100% |
| methylphenyl]propanal | | | | | |

Since the lowest concentration tested, i.e. 0.0178%, 3-[4-(2-methoxy-2-propanyl)-2-methylphenyl]propanal managed to repel >60% of the mosquitoes (Table 2). Already at the intermediate dose of 0.447%, three of the four stimuli, i.e. 3-(4-tert-butylphenyl) propanal, 3-(4-methoxyphenyl)-2-methylpropanal and 3-[4-(2-methoxy-2-propanyl)-2-methylphenyl]propanal managed to repel >95% of the mosquitoes (Table 2). These highly relevant results were confirmed at the highest tested dose, i.e. 1%, with all five stimuli reaching >95% of repellence (Table 2), meaning less than 4 mosquitoes landing per minute with the treatments compared to 23 mosquitoes per minute with the control.

TABLE 3
arm in cage results overtime with arm treated with 20% of 3-(4-methoxyphenyl)-2-methylpropanal.

| | time post-application | | | | | | | | |
|---|---|---|---|---|---|---|---|---|---|
| | 5 min | 1 h | 2 h | 3 h | 4 h | 5 h | 6 h | 7 h | 8 h |
| 3-(4- | 100% ± | 99.84% ± | 98.82% ± | 95.59% ± | 87.3% ± | 81.02% ± | 73.75% ± | 65.56% ± | 64.04% ± |
| methoxyphenyl)-2- | 0% | 0.1% | 1.4% | 4.5% | 7.5% | 8.2% | 3.0% | 1.4% | 4.9% |
| methylpropanal | | | | | | | | | |

Each time point value represents the mean ± SD percentage of repellence compared to untreated arm for three distinct human volunteers. Untreated arm received between 336 and 534 mosquito Aedes aegypti landings during the 3 min testing period.

### 2 Results of Warm Plato Assay for Arthropods Such as Ticks

TABLE 4
Percentage of repellence of ticks Ixodes ricinus on the warm
plate baited with a stimulus at four different concentrations.

| | 0 | 0.08 | 0.4 | 2 | 10 |
|---|---|---|---|---|---|
| | mg/mL | mg/mL | mg/mL | mg/mL | mg/mL |
| 3-[4-(2-methoxy-2- | 2.6% | 0.0% | 13.3% | 92.3% | 92.0% |
| propanyl)phenyl]propanal | | | | | |

As displayed in Table 4, 3-[4-(2-methoxy-2-propanyl]phenylpropanal managed to repel the ticks Ixodes ricinus in a dose response manner, reaching a total above 90% of repellence with 0.2% and 1% of stimulus applied.

1. An arthropod, preferably insect, control composition comprising a compound of formula (I) 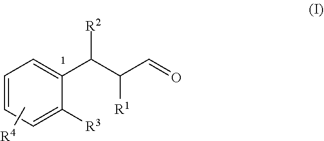
in the form of any one of its isomers or a mixture thereof; wherein R¹, R² and R³, independently from each other, represent, a hydrogen atom or a C₁₋₃ alkyl group; R⁴ represents a C₁₋₃ alkoxy group or a C₁₋₆ alkyl group, optionally substituted by a hydroxy or a C₁₋₃ alkoxy group; said R⁴ being, relative to position 1, a meta, a para substituent of the aromatic ring; provided that 3-(4-isopropylphenyl)-2-methylpropanal is excluded.

2. The arthropod control composition of claim 1 wherein compound is a compound of formula (II): 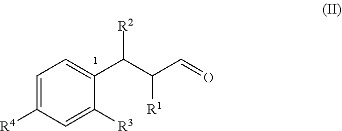
in the form of any one of its isomers or a mixture thereof; wherein R¹, R², R³, R⁴ and R^{5′} have the same meaning as defined in claim 1

3. The arthropod control composition of claim 1 wherein compound is a compound of formula (III) 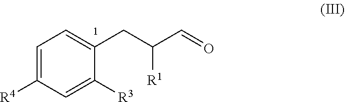
in the form of any one of its isomers or a mixture thereof; wherein R¹, R³ and R⁴ have the same meaning as defined above.

4. The arthropod control composition claim 1 wherein the compound is selected from a list consisting of: 3-[4-(2-methoxy-2-propanyl)-2-methylphenyl]propanal, 3-[4-(2-hydroxy-2-methylpropyl)phenyl]propanal, 3-(4-tert-butyl-2-methylphenyl) propanal, 3-(4-tert-butylphenyl) propanal, 3-(3-propan-2-ylphenyl) butanal and 3-(4-methoxyphenyl)-2-methylpropanal and mixtures thereof.

5. The arthropod control composition claim 1 wherein the compound is selected from a list consisting of: 3-[4-(2-hydroxy-2-methylpropyl)phenyl]propanal, 3-(4-tert-butyl-2-methylphenyl) propanal, 3-(4-tert-butylphenyl) propanal, 3-(3-propan-2-ylphenyl) butanal and 3-(4-methoxyphenyl)-2-methylpropanal and mixtures thereof

6. The arthropod control composition according to any of the previous claims, wherein the arthropod is an insect, preferably a mosquito.

7. The arthropod control composition according to any one of claims 1 to 6, further comprising an arthropod control co-ingredient being selected from the group consisting of: N, N-diethyl-3-methylbenzamide (DEET), ethyl butylacetylaminopropionate (IR3535); para-menthan-3,8-diol (PMD); 1-(1-methylpropoxycarbonyl)-2-(2-hydroxaethyl) piperidin (picaridin); Cedarwood oil China, Cedarwood oil Texas, Cedarwood oil Virginia, Cinnamon oil, Citronella oil, Cornmint oil, Cymbopogon winterianus oil fractionated hydrated cyclized, decanoic acid, Eucalyptus citriodora oil Eucalyptus citriodora oil hydrated cyclized, eugenol, Garlic oil, geraniol, Geranium oil, Lavender, Lavandula hybrida oil, Lavandin oil, Lemon oil, Lemongrass oil, Margosa extract, Metofluthrin, mixture of cis- and trans-p-menthane-3,8 diol, N, N-diethyl-meta-toluamide, nonanoic acid, Rosemary oil, Thyme oil, Wintergreen oil, 2,3,4,5-bis(butyl-2-ene) tetrahydrofurfural (MGK Repellent 11), cineole, cinnamaldehyde, citronellal, citronellol, coumarin, dibutyl phthalate, diethyl phthalate, dimethyl anthranilate, dimethyl phthalate, ethyl vanillin, Eucalyptus oil, delta-octalactone, delta-nonalactone, delta-decalactone, delta-undecalactone, delta-dodecalactone, gamma-octalactone, gamma-nonalactone, gamma-decalactone, gamma-undecalactone, gamma-dodecalactone, hydroxy citronellal, Lime oil, limonene, linalool, methyl anthranilate, Mint oil, myrcene, Neem oil, sabinene, β-caryophyllene, (1H-indol-2-yl) acetic acid, anethole, Anise oil, Basil oil, Bay oil, camphor, ethyl salicylate, Evergreen oils (pine oil), (1,3,4,5,6,7-hexahydro-1,3-dioxo-2H-isoindol-2-yl) methyl 2,2-dimethyl-3-(2-methylprop-1-enyl)cyclopropanecarboxylate (d-Tetramethrin), 3-Allyl-2-methyl-4-oxocyclopent-2-enyl-2,2-dimethyl-3-(2-methylprop-1-enyl)-cyclopropanecarboxy late (d-Allethrin), α-cyano-3phenoxybenzyl, 3-(2,2-dichlorovinyl)-2,2-dimethylcyclopropanecarboxylate (Cypermethrin), 2-methyl-4-oxo-3-(prop-2-ynyl)cyclopent-2-en-1-yl 2,2-dimethyl-3-(2-methylprop-1-enyl)cyclopropanecarboxylate (Prallethrin), Acetamiprid, Azadirachtin, Bendiocarb, Bifenthrin, boric acid, Chlorpyrifos, Deltamethrin, Diazinon, Dichlorvos, eugenol, Fipronil, Imidacloprid, linalool, Malathion, Maltodextrin, Metofluthrin, Nicotine, Permethrin, Pyrethrins, Pyrethroids, Rotenone, silicium dioxide (Kieselguhr), S-Methoprene, Spinosad (Spinosyn A), Spinosyn D, Tetramethrin, Transfluthrin, 1-(2,6,6-trimethylcyclohex-2-en-1-yl) but-2-en-1-one, 3-butylidene-2-benzofuran-1-one, 4-ethenyl-2-methoxyphenol, Cognac oil green, Labdanum extract (Cistus spp.), 5-pentyloxolan-2-one, chromen-2-one, 3,7-dimethylocta-2,6-dienal, 4-hydroxy-3-methoxybenzaldehyde, 2-methyl-5-prop-1-en-2-ylcyclohex-2-en-1-one, Mentha spicata oil, 6-hexyloxan-2-one, 5-methyl-2-propan-2-ylcyclohexyl]acetate, Nigella damascena oil, 2-phenylethanol, 6-pentyloxan-2-one, (4-methoxyphenyl) methyl acetate, Syzygium aromaticum oil, 3,4,4a,5,6,7,8,8a-octahydrochromen-2-one, 3,7,7-trimethylbicyclo[4.1.0]hept-3-ene, 2-phenylethyl 2-methylpropanoate, methyl 2-(3-oxo-2-pent-2-enylcyclopentyl)acetate, 4-(2-methoxypropan-2-yl)-1-methylcyclohexene, Mentha piperita oil, 2-methoxy-4-[prop-1-enyl]phenol, 2-methyl-3-(4-propan-2-ylphenyl) propanal, (4-methoxyphenyl) methanol, and mixtures thereof.

8. A method for arthropod, preferably insect, control which comprises bringing an insect into direct contact or in contact with vapors of a composition as defined in claims 1 to 7.

9. Use of a composition as defined in any one of claims 1 to 7 to control arthropods, preferably insects.

10. An arthropod, preferably insect, control article comprising the arthropod, preferably insect, control composition according to any one of claims 1 to 7.

11. The arthropod control article according to claim 10, wherein the article is a consumer product.

12. The arthropod control article according to any one of claims 10 and 11, wherein the article is a fabric care product, such as a liquid or solid detergent, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product, a dental care product), a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc.,); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner; a candle; a spray; a coil, an electric diffuser, a piezo diffuser, a liquid electric diffuser, a diffusor, a rubber septum, a wristband, a patch, a collar, an ear tag, clothes, fabrics, papers, a biochar, a cardboard, cellulosic pads, bed nets, a screen, curtains, a varnish or a paint.

13. The arthropod control article according to claim 11, wherein the article is an electric diffuser.
